(19) United States
(12) Patent Application Publication
(10) Pub. No.: US 2007/0031183 A1
(43) Pub. Date: Feb. 8, 2007

(54) Ball Bearing Swivel Connector

(75) Inventor: Woo-Kyung SIM, Paju-city, Kyungki-do (KR)

Correspondence Address: SHERIDAN ROSS;SUITE 3500, 1700 LINCOLN STREET, DENVER, CO, 80203, US

(73) Assignee: CENTRO CORPORATION, Koyang-city (KR)

(21) Appl. No.: 11/462,328

(22) Filed: Aug. 3, 2006

(30) Foreign Application Priority Data
Aug. 8, 2005 (KR) 20-2005-0022902

(51) Int. Cl. F16D 1/12

(52) U.S. Cl. 403/78

(57) ABSTRACT

The present invention relates to a ball bearing swivel connector for realizing a maximum tensile strength and relative rotation efficiency by using a minimum number of constituent elements at a minimum cost, preventing a fishing line from being tangled, and facilitating simpler manufacturing and assembly processes The ball bearing swivel connector includes an upper pin and a lower pin respectively extending to upper and lower ends of a body and having respective connecting rings penetrating therethrough, and a plurality of ball bearings for supporting the two pins in the body so that the two pins may relatively rotate. A race is formed at one end of the body extended as a small diameter tube bearing to support the plurality of ball bearings, and the other end of the body where the upper pin is inserted is formed to correspond to a shoulder of the upper pin in a drawing process so that the two pins in the body may be rotatably formed.

### CROSS-REFERENCE TO RELATED APPLICATION

This application claims priority to and the benefit of Korea Utility Model No. 20-2005-0022902 filed in the Korean Intellectual Property Office on Aug. 08, 2005, the entire contents of which are incorporated herein by reference.

### BACKGROUND OF THE INVENTION

(a) Field of the Invention

The present invention relates to a ball bearing swivel connector used to connect a hook and bait to a fishing line.

(b) Description of the Related Art

A swivel connector for connecting a hook and bait to a fishing line is required to perform a self rotation operation so that the fishing line may not become tangled when a current flows or a fish hooked by the hook tries to swim away.

A conventional swivel connector formed in a crane swivel type includes two connecting rings at upper and lower sides, and the two connecting rings are connected to a body of the swivel connector and perform the self rotation operation A configuration of the swivel connector is simplified so that the connecting rings at the upper and lower sides of the body may be respectively rotated, but there is a problem in that a rotation operation of the connecting rings is not smooth.

In a swivel connector disclosed in U.S. Pat. No. 4,955,749, respective ends of the swivel connector are formed in a pin shape, and one end of each pin includes a plug portion and a socket portion that are combined to each other so that they are relatively rotated.

However, manufacturing cost is increased since a large number of processes are required, and friction is generated on contact surfaces when the relative rotation is performed. Therefore, it is difficult to perform the relative rotation due to the friction, the swivel connector may not follow a rotation speed of the hook, and the fishing line may become tangled.

According to the ball bearing swivel connector disclosed as the prior art, a connecting ring is integrally coupled to one end of a body, another connecting ring coupled to the other end of the body is formed as a pin extended from the interior toward the exterior of the body, and the pin is rotated in the body by using ball bearings.

In the configuration of the above ball bearing swivel connector, the fishing line is not tangled since the connecting ring is smoothly rotated due to a point contact operation of the ball bearings and the connecting ring is rotated at the same speed as a hook rotation speed generated when a fish is hooked, however, there is a problem in that a tensile strength is weakened in a connecting part of the connecting ring.

In a swivel connector disclosed in Korea Utility Model No. 136827 based on U.S. Pat. No. 2,466,243 published in 1946, rather than using the above ball bearing swivel connector, the swivel connector includes an upper pin and a lower pin that are relatively rotated. The pins are respectively supported by ball bearings so that they may be relatively rotated, and therefore, they can efficiently prevent the fishing line from being tangled.

However, the number of constituent elements, including the body, the two pins, and two supporting units for supporting a plurality of ball bearings at the two ends of the body, is increased, a drawing process is performed twice since the two supporting units are respectively disposed in the body in respective drawing processes, it is required to provide a specific fixture so that the supporting units may not fall off from the body in the drawing processes, and the tensile strength is decreased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a ball bearing swivel connector for performing a relative rotation by using a minimum number of constituent elements.

The present invention has been made in an effort to provide a ball bearing swivel connector formed by performing a drawing process at one end of a body of the ball bearing swivel connector, and having upper and lower pins extended to both ends of the body that are disposed to relatively rotate in the body, so that the ball bearing swivel connector may have high tensile strength.

An exemplary ball bearing swivel connector according to an embodiment of the present invention includes an upper pin and a lower pin respectively extending to upper and lower ends of a body and having respective connecting rings penetrating therethrough, and a plurality of ball bearings for supporting the two pins in the body so that the two pins may relatively rotate. A race is formed at one end of the body extended as a small diameter tube bearing to support the plurality of ball bearings, and the other end of the body where the upper pin is inserted is formed to correspond to a shoulder of the upper pin in a drawing process so that the two pins in the body may be rotatably formed.

In addition, the upper and lower pins may relatively rotate since a center ball is interposed between flanges of the upper and lower pins that face each other in the body, and a position of the center ball is maintained by a recess and a ball seat formed as a semicircular recess.

Therefore, the exemplary ball bearing swivel connector according to the embodiment of the present invention is formed by using a minimum number of constituent elements, including the body, the two pins, and the plurality of ball bearings, and a fishing line may be prevented from being tangled since the upper and lower pins at both ends of the body are disposed in the body to relatively rotate. In addition, a drawing process is only performed at one end of the body, thereby simplifying the manufacturing process.

### BRIEF DESCRIPTION OF THE DRAWINGS

FIG. 1 shows a diagram of a configuration of a ball bearing swivel connector according to an exemplary embodiment of the present invention with the constituent elements separated.

FIG. 2 shows a diagram of an exterior of the assembled ball bearing swivel connector.

### DESCRIPTION OF REFERENCE NUMERALS INDICATING PRIMARY ELEMENTS IN THE DRAWINGS

2: Body

4: Tube bearing

6: Race

8: Ball

10: Lower pin

12, 20: Flanges

14: Recess

16: Ball spacer

18: Upper pin

22: Ball seat

24, 26: Connecting rings

28, 30: Pin holes

32: Shoulder

### DETAILED DESCRIPTION OF THE EMBODIMENT

An exemplary embodiment of the present invention will hereinafter be described in detail with reference to the accompanying drawings.

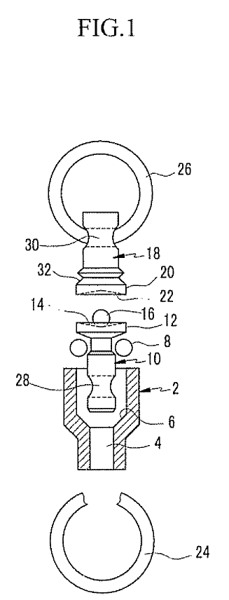

FIG. 1 shows a diagram of a configuration of a ball bearing swivel connector according to an exemplary embodiment of the present invention. A small diameter tube bearing 4 is extended to an end of a body 2, and a race 6 is formed in the body 2.

A plurality of balls 8 are interposed as bearings in the race 6 so that a flange 12 on an upper end of a lower pin 10 may be rotatably supported.

A recess 14 is formed on an upper surface of the flange 12, and a center ball 16 is provided on a center of the recess 14 to support a flange 20 of an upper pin 18.

A ball seat 22 formed as a semicircular recess is provided on the flange 20 of the upper pin 18, and the ball seat 22 corresponds to the recess 14. Accordingly, a center of the upper pin 18 may be supported in the body 2 by the center ball 16.

The center ball 16 may be omitted from the exemplary embodiment of the present invention since it is interposed to facilitate the relative rotation between the upper and lower pins 18 and 10 that are disposed to face each other in the body 2.

Pin holes 28 and 30 are respectively formed in the lower pin 10 and the upper pin 18 so that connecting rings 24 and 26 are respectively penetrated through the lower pin 10 and the upper pin 18, and in addition, the upper pin 18 forms a shoulder 32 neighboring the flange 20.

According to the ball bearing swivel connector of the exemplary embodiment of the present invention, the drawing process is performed only at one end of the body 2.

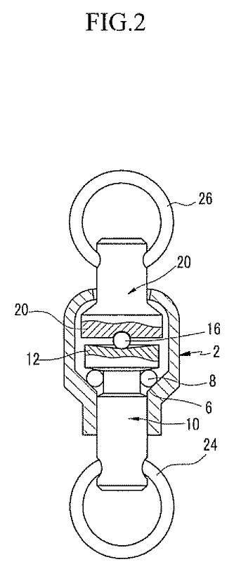

That is, as shown in FIG. 2, when the lower pin 10 penetrates the small diameter tube bearing 4 of the body 2, the lower pin 10 is rotatably provided since the plurality of balls 8 are interposed under the flange 12 and are supported by the race 6 of the body 2. Further, the center ball 16 is interposed between the recess 14 on the upper surface of the flange 12 and the flange 20 of the upper pin 18, which is formed to face the flange 12 of the lower pin 10, the drawing process is performed at one end of the body 2 (in further detail, the end where the upper pin 18 is inserted) to reduce a diameter thereof, and the end of the body 2 is formed to correspond to the shoulder 32 of the upper pin 18, and therefore, the center ball 16 is provided between the lower pin 10 and the upper pin 18 so that the lower pin 10 and the upper pin 18 may relatively rotate and form a swivel connector.

The ball bearing swivel connector according to the exemplary embodiment of the present invention is used to connect a fishing line rig to a fishing line extended from a fishing pole in a like manner of the conventional swivel connector. After connecting the fishing line rig to the fishing line, the two pins 10 and 18 relatively rotate so that the fishing line may not become tangled.

As described above, the ball bearing swivel connector according to the exemplary embodiment of the present invention is formed by using a minimum number of constituent elements, including the body, the two pins, and the plurality of balls, and the fishing line may not become tangled since the upper and lower pins at both ends of the body are relatively rotated by being supported by the plurality of balls. In addition, manufacturing and assembly processes may be simplified since the drawing operation is only performed at one end of the body where the upper pin is inserted when the constituent elements are combined.

While this invention has been described in connection with what is presently considered to be a practical exemplary embodiment, it is to be understood that the invention is not limited to the disclosed embodiment, but, on the contrary, is intended to cover various modifications and equivalent arrangements included within the spirit and scope of the appended claims.

What is claimed is:

1. A ball bearing swivel connector comprising:
an upper pin and a lower pin respectively extending to upper and lower ends of a body and having respective connecting rings penetrating therethrough; and
a plurality of ball bearings for supporting the two pins in the body so that the two pins may be relatively rotated,
wherein a race extended as a small diameter tube bearing to support the plurality of ball bearings is formed at one end of the body, and the other end of the body where the upper pin is inserted is formed to correspond to a shoulder of the upper pin in a drawing process so that the two pins in the body may be rotatably formed.

2. The ball bearing swivel connector of claim 1, wherein the upper and lower pins may be relatively rotated since a center ball is interposed between flanges of the upper and lower pins that face each other in the body, and a position of the center ball is maintained by a recess and a ball seat formed as a semicircular recess.
